(19) United States
(12) Patent Application Publication
(10) Pub. No.: US 2002/0161782 A1
(43) Pub. Date: Oct. 31, 2002

(54) Method for automated management of received messages

(76) Inventors: Bruno Bozionek, Borchen (DE); Rainer Zimmermann, Paderborn (DE)

Correspondence Address: Bell, Boyd & Lloyd LLC, P.O. Box 1135, Chicago, IL, 60690, US

(21) Appl. No.: 10/100,953

(22) Filed: Mar. 18, 2002

(30) Foreign Application Priority Data
Mar. 19, 2001 (DE) 101 133 04.9

(51) Int. Cl. G06F 7/00

(52) U.S. Cl. 707/104.1

(57) ABSTRACT

A method and computer software program for the automated management of received messages, particularly E-mail messages, wherein a repeat presentation time, possibly a priority criterion, and a category are issued for an E-mail message after it has been opened, and the E-mail message is optionally saved in a central task folder or in accordance with the attributes in corresponding directories.

### BACKGROUND OF THE INVENTION

The present invention relates to a method and to a computer software program for the automated management of received messages; namely, E-mail messages. In particular, the present invention relates to the saving and later automatic calling-up of received messages in accordance with particular criteria.

As a rule, an Internet user receives a multiplicity of E-mail messages in the course of a day or of a week. Frequently, however, he/she lacks the time to immediately read all E-mail messages received, not to mention to answer them. For example, this is often the case after a business trip during which a multiplicity of E-mail messages have accumulated.

The Internet user is forced to open all E-mail messages and to decide in each individual case which messages he/she wishes to answer immediately, at a later time or not at all. If the user decides to answer an E-mail message at a later time, he/she must, as a rule, generate a so-called task manually step by step for the corresponding E-mail message, in which task a time until repeat presentation, possibly a priority criterion and a category and the E-mail message are added as attachment. As an alternative, the user can mark the E-mail message again as unread or copy it manually into a folder for unprocessed messages. This is cumbersome and time consuming.

It is an object of the present invention, therefore, to simplify the management of messages to be answered at a later time.

### SUMMARY OF THE INVENTION

Accordingly, the present invention proposes to assign and attach a repeat presentation time to a message which has been read or opened and the repeat presentation time specifies when the reader is planning to answer the message. The message is then automatically transferred as a task into a task folder and saved therein, including the attached repeat presentation time.

The message is preferably an E-mail message.

The subject of the E-mail message could be automatically saved as task title and the E-mail message itself as attachment in the task folder.

The E-mail messages which have been appropriately processed and saved in the task folder are again indicated at the corresponding assigned repeat presentation time.

Furthermore, an answering priority information item can be assigned to an E-mail message. E-mail messages having the same repeat presentation time, thus, can be indicated in accordance with the preassigned answering priority information item in the task folder.

However, it also should be possible for all correspondingly processed E-mail messages to be indicated in the task folder in accordance with the assigned answering priority information item, independently of the assigned data information.

Furthermore, a category information item (private, business, etc.) can be assigned to an E-mail message. Accordingly, it also should be possible to indicate the E-mail messages in accordance with this preassigned category information in the task folder.

E-mail messages stored as a task are generally stored in a folder or subfolder. It is optional, however, whether they are saved in dependence on categories, priorities or repeat presentation times in the subfolder or in a central folder since various views also can be offered in a central folder via corresponding filters; e.g., all tasks of a category, all tasks of a priority, etc.

Furthermore, a computer software program is proposed which executes a method according to the steps described above in cases in which it is loaded into the memory of a data processing device.

However, the representation mechanism also can be introduced into an existing (work group) groupware program (e.g., Microsoft Outlook).

Additional features and advantages of the present invention are described in, and will be apparent from, the following Detailed Description of the Invention and the Figures.

### BRIEF DESCRIPTION OF THE FIGURES

FIG. 1 shows a flowchart with the method steps of the present invention executed in an automated management of received E-mail messages.

FIG. 2 shows an opened E-mail message in a so-called inbox, and the same E-mail message saved in a task folder.

### DETAILED DESCRIPTION OF THE INVENTION

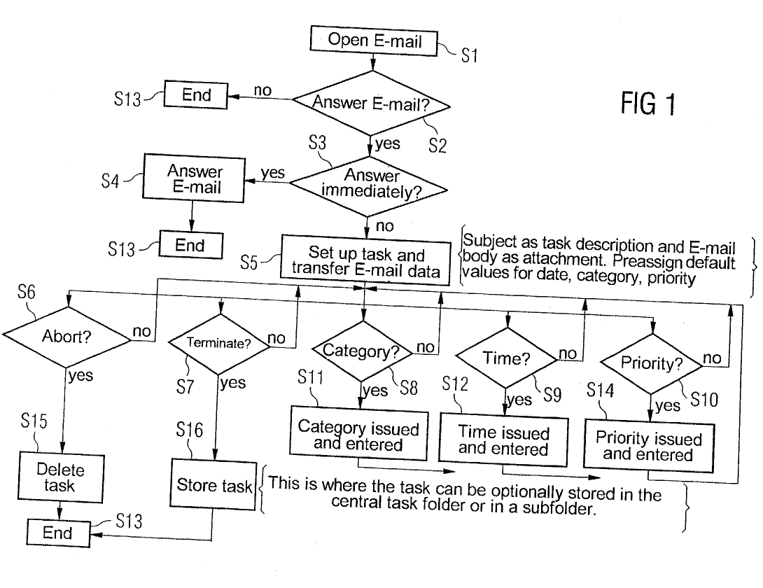

Referring to FIG. 1, a received E-mail message is opened in an inbox folder in a step S1 in order to read it. In a next step S2, a decision is made whether this E-mail message is to be answered. If this is not so, the E-mail message is deleted in a step S13 or remains in the inbox folder. Thus, it should be left to the user whether an E-mail message is deleted or remains in the inbox folder after it has been read and subsequently closed.

If, on the other hand, the message is to be answered, a decision first must be made in a step S3 whether the answer is to be given immediately or only at a later time. Immediate answering is done in a step S4. If it is decided in step S3 that the answer is to be given at a later time, a criterion must be issued to the E-mail message which is used in a later repeat presentation of the message. This criterion can be a priority criterion (e.g., a high priority or a low priority), a category (private, business, etc.) or a repeat presentation time, taking into consideration a clock time and a date.

If an option “answer later” is selected in S3, a task is automatically created, the subject of the E-mail message is preassigned as task description and the E-mail message is appended to the task as attachment.

The corresponding criteria (repeat presentation time, priority and category) can be preassigned default values. This is particularly appropriate in the case of a repeat presentation time which (for example preassigned with three days) in principle causes a repeat presentation of the E-mail message three days after it has been opened.

However, the preassigned default values for a corresponding criterion also can be changed manually in steps S8 to S10. If a category is to be issued after confirmation in step S8, this is done in a step S11. In the case where a decision is made for a repeat presentation time in step S9, time and date of the repeat presentation are entered in a step S12. After a decision has been made for a priority in step S10, this is issued in a step S14.

In a step S6, the user can decide at any time to abort the process and to delete the task set up in step S5 in a step S15.

However, the user also can decide to terminate the process properly in a step S7 (which corresponds to the normal case) and optionally save the task in a central task folder or in a subfolder in a step S16. If a central task folder is used, it can be a specially started folder or a standard task folder set up by the user.

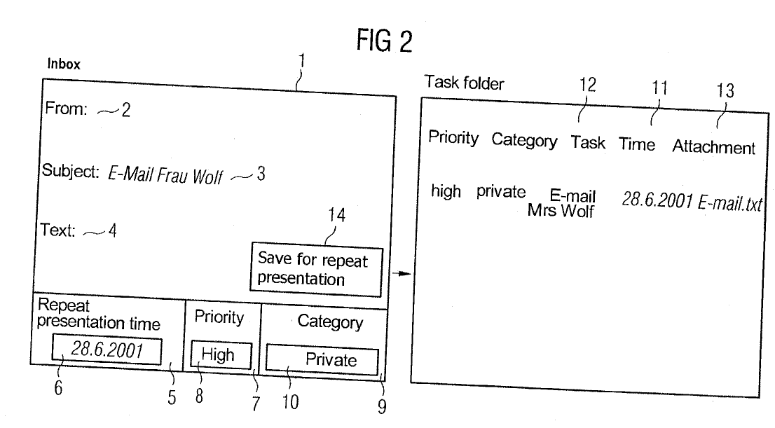

In FIG. 2, the E-mail message opened for reading is shown in a suitable inbox window 1. The sender 2 of the E-mail message is specified in an upper section 2. This is followed by the subject 3 (“E-mail Mrs Wolf” in the present exemplary embodiment) and, finally, the actual text 4 of the e-mail message follows. According to the present invention, the criteria repeat presentation time 5, priority 7 and category 9, which can be assigned by so-called buttons, are located in a menu bar located at the lower edge of the window. In addition, the menu bar contains a button 14 for saving the E-mail message in a central task folder or in a subfolder corresponding to the assigned criteria.

The buttons 5, 6 and 7 in the lower menu bar contain the associated input windows 6, 8, 10 for the corresponding criteria. In the present exemplary embodiment, for example, the repeat presentation is due on 28.6.2001, the message has a high priority and is private.

It is necessary to input at least one criterion for the repeat presentation, advantageously the repeat presentation time, in order to save the E-mail message in a task folder 11 by operating the button 14. The subject of the E-mail message originally received is automatically used for designating the task 12. The text of this E-mail message is appended to the task folder in the form of a text file 13.

When additional repeat presentation criteria are input (e.g., priority and category), the corresponding task folder 11 can be filed in the subfolders corresponding to the criteria.

If the mechanism for transferring the E-mail message into a task is implemented (e.g., in a groupware program such as Microsoft Outlook), all other functions offered as standard by this program (for example, forwarding the task to any E-mail user) can be utilized.

This dispenses with the awkward manual calling-up of criteria issuing functions for characterizing E-mail messages received, so that these can be managed sorted accordingly.

Although the present invention has been described with reference to specific embodiments, those of skill in the art will recognize that changes may be made thereto without departing from the spirit and scope of the invention as set forth in the hereafter appended claims.

1. A method for managing received messages, the method comprising the steps of:
setting up a task in a task folder;
transferring data of a message which has been read into the task folder;
automatically preassigning and appending criteria with default values, the criteria including at least one of repeat presentation time, answering priority information and category information, with the repeat presentation time specifying a time at which a reader plans to answer the message; and
automatically transferring and saving the message including the appended criteria in one of a central task folder and a subfolder.

2. A method for managing received messages as claimed in claim 1, wherein default values for the criteria are changed.

3. A method for managing received messages as claimed in claim 1, wherein the messages are E-mail messages.

4. A method for managing received messages as claimed in claim 3, the method further comprising the steps of:
automatically saving a subject of the E-mail message as a task title; and
saving the E-mail message as an attachment in the task folder.

5. A method for managing received messages as claimed in claim 3, wherein the E-mail messages are indicated in the task folder in accordance with the assigned repeat presentation time.

6. A method for managing received messages as claimed in claim 3, wherein the E-mail messages having a same repeat presentation time are indicated in accordance with the assigned answering priority information in the task folder.

7. A method for managing received messages as claimed in claim 3, wherein the E-mail messages are indicated in accordance with the assigned answering priority information in the task folder independently of assigned date information.

8. A method for managing received messages as claimed in claim 3, wherein the E-mail messages are indicated in accordance with the assigned category information in the task folder.

9. A computer software program for executing a method for managing received messages, when loaded into a memory of a data processing device, wherein the method includes the steps of:
setting up a task in a task folder;
transferring data of a message which has been read into the task folder;
automatically pre-assigning and appending criteria with default values, the criteria including at least one of repeat presentation time, answering priority information and category information, with the repeat presentation times specifying a time at which a reader plans to answer the message; and
automatically transferring and saving the message, including the appended criteria, in one of a central task folder and a subfolder.
